(19) United States
(12) Patent Application Publication
(10) Pub. No.: US 2005/0174606 A1
(43) Pub. Date: Aug. 11, 2005

(54) Scan data transmitter and a scan data transmission system

(75) Inventors: Yuji Matsueda, Nagano (JP); Satoshi Iinuma, Nagano (JP); Yukinobu Momozono, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/031,678

(22) Filed: Jan. 7, 2005

(30) Foreign Application Priority Data
Jan. 8, 2004 (JP) P. 2004-002881

(51) Int. Cl. H04N 1/04; G06F 15/00

(52) U.S. Cl. 358/402; 358/474

(57) ABSTRACT

The scan data transmitter and the scan data transmission system are designed to allow the user to issue, at a time, execution instructions on processing of storing an image data file of a manuscript into a folder and processing of transmitting an e-mail to which the image data file of the manuscript is attached, that is, to simultaneously specify the mail address as a destination of the mail and the folder into which the file is to be stored.

### BACKGROUND OF THE INVENTION

The present invention relates to a scan data transmitter and a scan data transmission system capable of generating image data of a manuscript and storing a file of the image data into a folder as well as generating image data of a manuscript and transmitting an e-mail to which the image data file is attached.

Some of the digital multifunction devices recently available on the market are ready for “scan-to-mail processing” or “scan-to-file processing” when they are connected to a LAN and a predetermined program (hereinafter referred to as a feature addition program) has been installed in a computer on the LAN (refer to CS-7000 Network Operation Guide from Seiko Epson Corporation) As schematically shown in FIG. 23A, the “scan-to-mail processing” refers to processing where scan data (image data of a manuscript generated by way of a scanner of a digital multifunction device) is transmitted from the digital multifunction device to a computer where a feature addition program is installed and an e-mail to which a file of data obtained by processing the scan data (data in converted form) is attached is transmitted to several destinations specified by the user by way of the computer. As schematically shown in FIG. 23B, the “scan-to-file processing” refers to processing where scan data is transmitted from the digital multifunction device to a computer where a feature addition program is installed and a file of data obtained by processing the scan data is transmitted to a destination specified by the user (shared folder in a file server) by way of the computer.

In an office, in some cases, when an image data file of a manuscript is stored in a shared folder, an e-mail to which the image data file of the manuscript is attached must be transmitted. The digital multifunction device according to the related art has to perform scan-to-mail processing and scan-to-file processing in this order to complete the whole process. To be more precise, the digital multifunction device takes time and trouble in storing an image data file of a manuscript into a shared folder and transmitting an e-mail to which the data file of the manuscript is attached.

### SUMMARY OF THE INVENTION

An object of the invention is to provide a scan data transmitter and a scan data transmission system capable of performing processing of storing an image data file of a manuscript into a shared folder and transmitting an e-mail to which the data file of the manuscript is attached in a fashion which requires less time and workload than in a related art.

In order to solve the aforesaid object, the invention is characterized by having the following arrangement.
(1) A scan data transmitter to be connected to a network comprising:
   an image data generator that generates image data representing an image on a manuscript set thereon;
   a user-interface unit that allows a user to specify process contents to be executed and allows the user to specify both of or either a file path of a folder into which a file of image data generated by the image data generator is stored and a designation mail address of an e-mail to which the file of the image data is attached; and
   an image data transmitter that, when a processing start instruction is input, performs:
   in case the user specifies only the file path to the user-interface unit, first storage processing which causes the image data generator to generate the image data and stores a file concerning the image data into the folder identified by the specified folder path, in case the user specifies only the designation mail address to the user-interface unit, first mail transmission processing which causes the image data generator to generate the image data and transmits an e-mail to which a file concerning the image data is attached to the designation mail address specified by the user, and
   in case the user specifies the file path and the designation mail address, second storage processing which causes the image data generator to generate the image data and stores a file concerning the image data into a folder identified by the folder path specified by the user and second mail transmission processing which transmits the e-mail to which a file concerning the image data is attached to the designation mail address specified by the user.
(2) The scan data transmitter according to (1), wherein the image data transmitter skips the first mail transmission processing and the second transmission processing and executes the first storage processing and the second storage processing, in case generation of image data by the image data generator is not successfully terminated.
(3) The scan data transmitter according to (1), wherein the user-interface unit allows the user to specify a file format, and
   in case the file format specified by the user to the user-interface means is a predetermined file format which is either a compressed format or uncompressed format, the image data transmitter assumes the file format as the compressed file format of the predetermined file format for e-mail transmission processing and assumes the file format as the uncompressed file format of the predetermined file format for file storage processing.
(4) The scan data transmitter according to (3), wherein, in case the user specifies the file path and the mail address to the user-interface unit, the image data transmitter performs the second storage processing which causes the image data generator to generate the image data, creates an uncompressed file having the predetermined file format concerning the image data and stores the file into a folder identified by the folder path specified by the user, and performs the second mail transmission processing of transmitting the e-mail to which the uncompressed file is attached.
(5) A scan data transmission system comprising an information processor and an auxiliary information processor,
   wherein the auxiliary information processor includes:
   a first processing execution unit which stores a file concerning image data transmitted from the auxiliary information processor into a folder identified by a folder path transmitted from the information processor;
   a second processing execution unit which performs processing of transmitting an e-mail, to which a file concerning the image data transmitted from the information processor is attached, to a designation mail address transmitted from the information processor; and
   a third processing execution unit which performs processing of storing a file concerning the image data into a folder identified by a folder path transmitted from the information processor and processing of transmitting an e-mail to which a file concerning the image data is attached to the designation mail address transmitted from said information processor, and
   wherein the information processor includes:
   an image data generator for generating image data corresponding to an image on a manuscript;
   a user-interface unit which allows the user to specify processing contents to be executed and allows the user to specify both of or either a file path of a folder into which a file of image data generated by the image data generator is stored and a designation mail address of an e-mail to which the file of image data generated by the image data generator is attached; and
   a controller that, when a processing start instruction is input, operates:
   in case the user specifies only a file path to the user-interface unit, the first processing unit;
   in case the user specifies only a mail address to the user-interface unit, the second processing unit; and
   in case the user specifies a file path and a mail address to the user-interface unit, the third processing unit.
(6) The scan data transmission system according to (5), wherein
   when the controller operates the first processing unit, the controller causes the image data generator to generate the image data and transmits the image data and the folder path specified by the user to the auxiliary information processor,
   when the controller operates the second processing unit, the controller causes the image data generator to generate image data and transmits the image data and the mail address specified by the user to the auxiliary information processor, and
   when the controller operates the third processing unit, the controller causes the image data generator to generate the image data and transmits the image data and the file path and the mail address which are specified by the user to the auxiliary information processor.
(7) The scan data processing system according to (5), wherein the auxiliary information processor is a computer storing an auxiliary information processing program for operating a computer to function as the first processing execution unit, the second processing execution unit, and the third processing execution unit.

The scan data transmitter having such a configuration according to the invention functions as a device which allows the user to issue, at a time, execution instructions on processing of storing an image data file of a manuscript into a folder and processing of transmitting an e-mail to which the image data file of the manuscript is attached, as well as a device which completes processing of storing the image data file of the manuscript into the folder and processing of transmitting the e-mail to which the image data file of the manuscript is attached, by way of a singles can of the manuscript. Thus, by using the scan data transmitter according to the invention, it is possible to perform processing of storing an image data file of a manuscript into a folder and transmitting an e-mail to which the data file of the manuscript is attached in a fashion which requires less time and workload than in a related art.

With such a configuration, it is possible to implement a scan data transmitter which allows a small-size file to be attached to an e-mail without separately setting a file format concerning a file to be attached to an e-mail and a file format concerning a file to be stored, the scan data transmitter not requiring a special program for browsing a file to be stored.

To employ such a configuration, it is desirable to cause a compressed file out of an uncompressed format just created, in case both an uncompressed file (file of uncompressed format) and a compressed file (file of compressed format) has to be created.

The scan data transmission system according to the invention is a system capable of performing processing of storing an image data file of a manuscript into a folder and transmitting an e-mail to which the data file of the manuscript is attached in a fashion which requires less time and workload than in a related art.

### BRIEF DESCRIPTION OF THE DRAWINGS

FIG. 1 illustrates the configuration and usage pattern of a scan data transmission system according to an embodiment of the invention;

FIG. 2 is an external view of a digital multifunction device included in the scan data transmission system according to the embodiment;

FIG. 3 is a block diagram of the digital multifunction device;

FIG. 4 is an external view of a control unit included in the digital multifunction device;

FIG. 5 illustrates the information stored into a scan agent computer included in the scan data transmission system;

FIG. 6 is a flowchart of IP address registration/check processing executed by the scan agent computer;

FIG. 7 illustrates a scan user setting page provided by the scan agent computer;

FIG. 8 illustrates an option setting page provided by the scan agent computer;

FIG. 9 illustrates a folder setting page provided by the scan agent computer;

FIG. 10 illustrates a destination setting page provided by the scan agent computer;

FIG. 11 illustrates a destination group setting page provided by the scan agent computer;

FIG. 12 illustrates a copy basic screen displayed by the control unit;

FIG. 13 is a sequence chart showing the operation procedure of the scan data transmission system;

FIG. 14 illustrates a user name selection screen displayed by the control unit;

FIG. 15 illustrates a scan basic screen displayed by the control unit;

FIG. 16 illustrates a file format selection screen displayed by the control unit;

FIG. 17 illustrates a manuscript type selection screen displayed by the control unit;

FIG. 18 illustrates a scan destination selection screen displayed by the control unit;

FIG. 19 illustrates a scan destination check/deletion screen displayed by the control unit;

FIG. 20 is a sequence chart showing the operation procedure of the scan data transmission system;

FIG. 21 is a flowchart of data transmission processing executed by the scan agent computer;

FIGS. 22A to 22C illustrate processing completion notice mails created and transmitted by the scan agent computer; and

FIGS. 23A and 23B illustrate scan-to-mail processing and scan-to-file processing performed by an existing system.

### DETAILED DESCRIPTION OF PREFERRED EMBODIMENTS

The best embodiment to implement the invention is detailed below referring to the drawings.

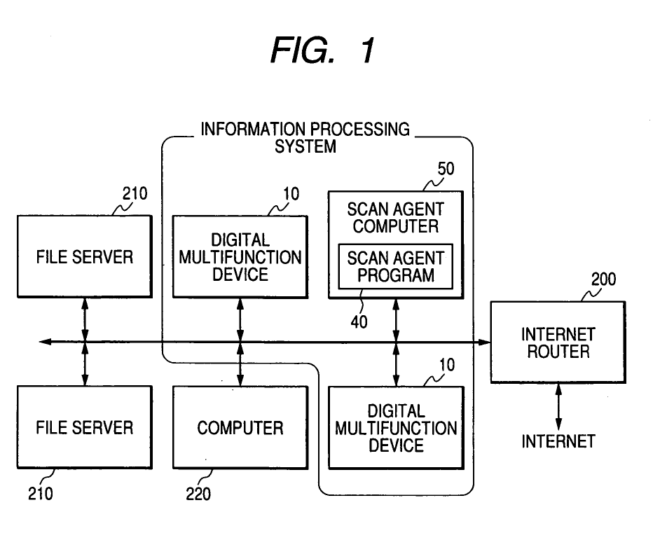

The hardware configuration of a scan data transmission system according to an embodiment of the invention is described below referring to FIGS. 1 through 4.

As shown in FIG. 1, the scan data transmission system according to this embodiment is a system where one or more (two in FIG. 1) digital multifunction devices 10 (corresponding to an information processor) and a scan agent computer 50 (corresponding to an auxiliary information processor) are connected via a network. The scan data transmission system is a system connected to a network comprising an internet router 200, several file servers 210 and several computers (one computer in FIG. 1) 220.

The internet router 200 is a device for connecting each computer 220 to the Internet. The file server 210 is a computer to which a shared folder is set. The computer 200 is a computer in which a web browser is installed, the computer used by the administrator of the scan data transmission system or a general user.

The scan agent computer 50 is a computer in which is installed a scan agent program 40 (corresponding to an auxiliary information processing program) developed for this scan data transmission system. While the feature of the scan agent program 40 will be described later, the scan agent program 40 requires setting of an administrator's name, a password, a work folder and a mail server in installation (setup).

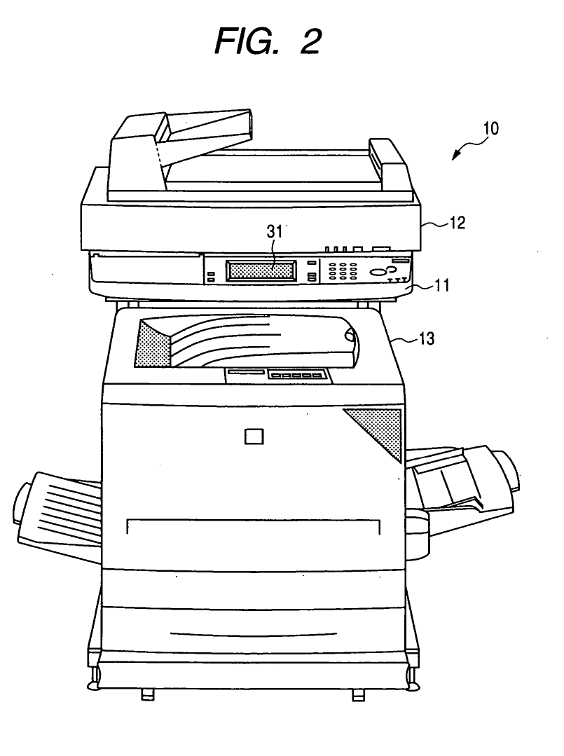

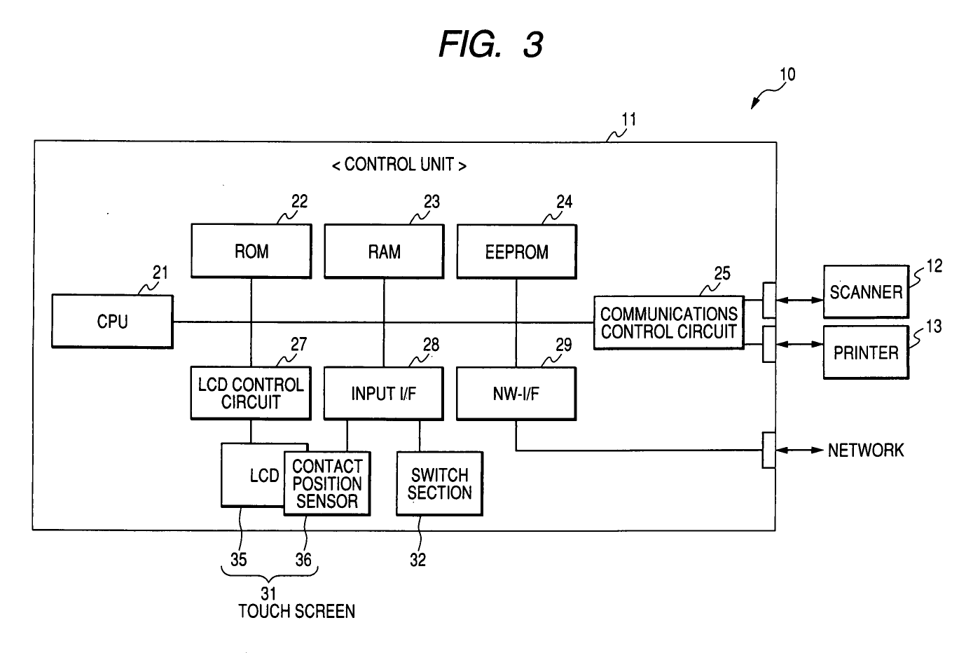

The digital multifunction device 10 is a device having an external appearance and hardware configuration respectively shown in FIGS. 2 and 3. The digital multifunction device 10 is a combination of a control unit 11, a scanner 12 and a printer 13 so as to provide the same external appearance as a general digital multifunction device/copier.

A printer 13 used for the digital multifunction device 10 is a printer available as a peripheral device of a computer with an extension board attached for implementing the digital multifunction device 10, that is, for connecting the control unit 11 and the printer 13. The scanner 12 is a scanner available as a peripheral device of a computer with an extension board attached for implementing the digital multifunction device 10, that is, for connecting the control unit 11 and the scanner 12.

The control unit 11 is, as shown in FIG. 3, comprises a CPU 21, a ROM 22, a RAM 23, an EEPROM 24, a communications control circuit 25, an LCD control circuit 27, an input interface circuit (input I/F) 28, a network interface circuit (NM-I/F) 29, a touch screen 31, and a switch section 32.

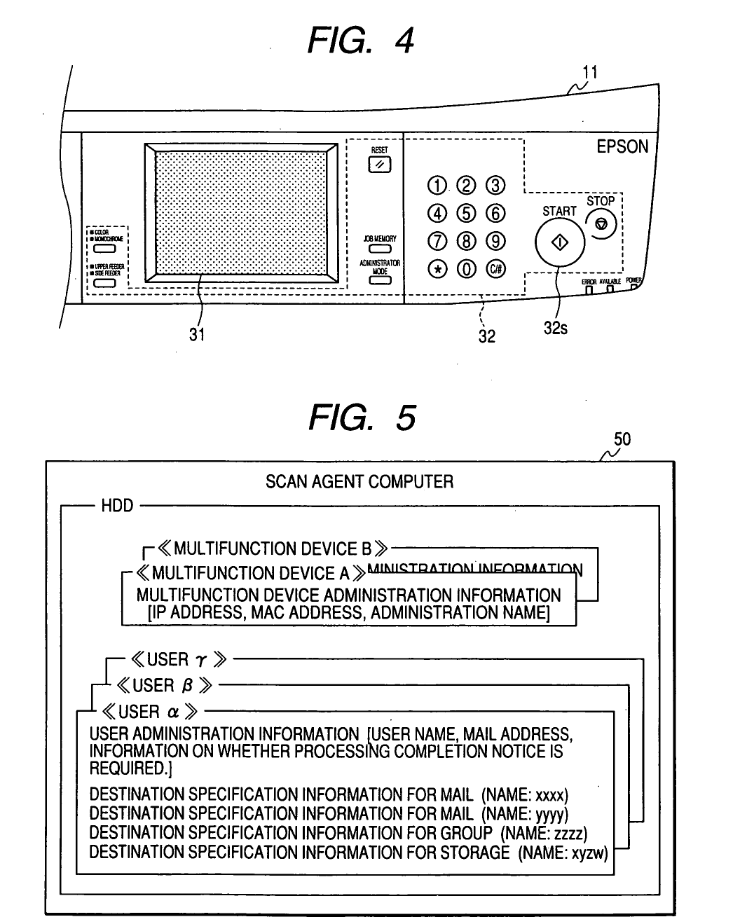

The touch screen 31 of the control unit 11 is a device comprising a liquid crystal display (LCD) 35 on which a transparent contact position sensor 36 is provided. The switch section 32 (refer to FIGS. 3 and 4) is a unit comprising various pushbutton switches such as a start button 32s and a ken-key pad provided on the enclosure of the control unit 11 and a control circuit for these switches.

The CPU 21 (FIG. 3) is a control circuit for integrally controlling each section of the digital multifunction device 10 (each section of the control unit 11, the scanner 12 and the printer 13). The ROM 22 is a read-only memory in which is recorded data used by a program which specifies the operation procedure of the CPU 21 and the CPU 21 (various programs). The RAM 23 is a memory from which a program recorded in the ROM 22 is read and also a memory used as a work area for the CPU 21 (or various programs). The communications control circuit 25 is a circuit used by the CPU 21 to communicate information to/from the scanner 12 or the printer 13, for example transmitting commands, receiving image data, and transmitting print data.

The LCD control circuit 27 is a circuit which causes the touch screen 31 (LCD 35) to display an image (screen) instructed by the CPU 21. The input interface circuit 28 is a circuit for communicating the operation of the user (operator of the digital multifunction device 10) on the ten-key pad 32 or the touch screen 31 (contact position sensor 36) to the CPU 21. The network interface circuit 29 is a circuit for connecting the control unit 11 to a LAN.

The EEPROM 24 is a nonvolatile rewritable memory mounted on the control unit 11 so as to store various information such as a device IP address and an agent IP address which must be retained even when the power is turned off.

Operation of the scan data transmission system is described below.

The scan data transmission system is designed to operate with the information schematically shown in FIG. 5 stored in the HDD of the scan agent computer 50.

To be more precise, the scan data transmission system operates in a state where multifunction device administration information for each digital multifunction device 10 (Digital Multifunction Device A and Digital Multifunction Device B in the figure) and user administration information and several destination specification information items (destination specification information for mail/group/storage) per user (user α, β, γ in the figure) are stored in the HDD of the scan agent computer 50.

The multifunction device administration information for each digital multifunction device 10 stored in the scan agent computer 50 comprises the IP address, MAC address and administration name of the corresponding digital multifunction device 10. Registration of the multifunction device administration information to the scan agent computer 50 is automatically made when initial setting of the digital multifunction device 10 is made.

To be more precise, the control unit 11 is a unit which requires assignment of an IP address (hereinafter referred to as a device IP address) and storage of an IP address assigned to the scan agent computer 50 (hereinafter referred to as an agent IP address) in its installation (integration into a network).

The control unit 11 is designed so that such procedures will be made by operating the ten-key pad and the touch screen 31 on the control unit 11 and the device IP address and the agent IP address set through the procedures will be stored on the EEPROM 24.

The control unit 11 is designed to transmit, in case a device IP address and an agent IP address are stored in the EEPROM 24 or the device IP address and the agent IP address have been changed at power on, an IP address registration/acknowledgment request comprising information indicating the device IP address, the MAC address of the unit (network interface circuit 29), the model name of the unit, the model name of the scanner 12 and attachment of an optional device (ADF) of the scanner 12, to a device identified by the agent IP address stored in the EEPROM 24.

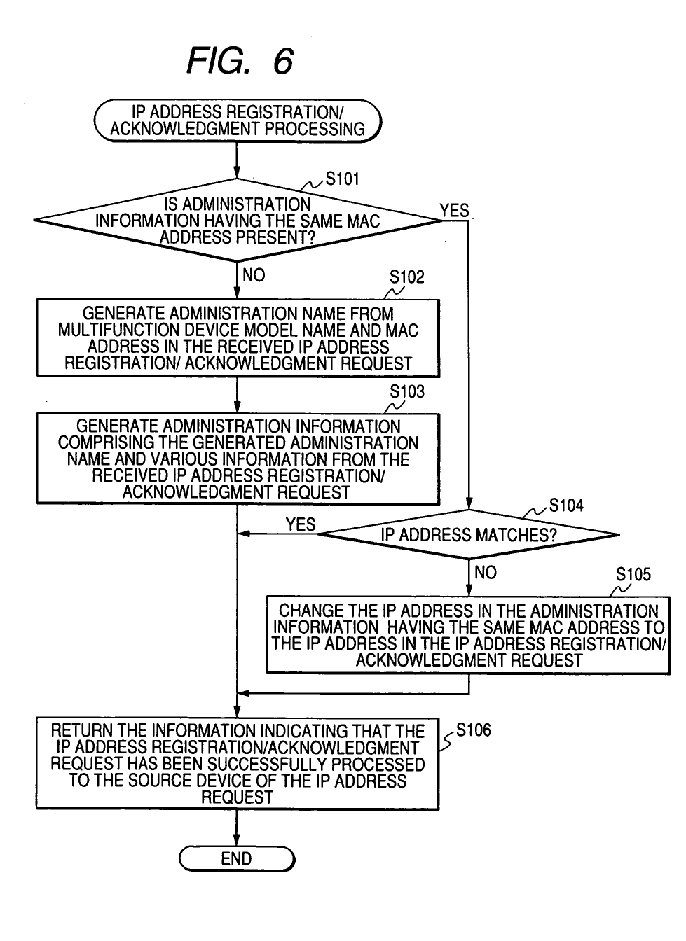

The scan agent program 40 is a program which causes the scan agent computer 50 to execute the IP address registration/acknowledgment processing in the procedure shown in FIG. 6, on reception of the IP address registration/acknowledgment request.

The scan agent computer 50, receiving the IP address registration/acknowledgment request, determines whether the multifunction device administration information corresponding to the IP address registration/acknowledgment request is stored in the computer (in a predetermined folder in the HDD of the computer) (S101). The multifunction device administration information corresponding to the received IP address registration/acknowledgment request comprises the same MAC address as that included in the received IP address registration/acknowledgment request (refer to FIG. 5).

In case the multifunction device administration information corresponding to the received IP address registration/acknowledgment request is not stored in the computer (S101; NO), the scan agent computer 50 generates an administration name by combining the model name of the control unit 11 and part of the MAC address included in the IP address registration/acknowledgment request (S102). Then the scan agent computer 50 generates the multifunction device information including the generated administration name and each information item included in the received IP address registration/acknowledgment request and stores the resulting information into the computer (S103). The actual processing in S102 is processing to generate a character string comprising the model name of the control unit 11 followed by the last four letters of the MAC address. The actual processing in S103 is processing to generate a folder having the same folder name as that of the MAC address under a predetermined folder created on the HDD and creating a multifunction device administration information file in the created folder.

Having generated and stored the multifunction device administration information (S103), the scan agent computer 50 returns the information indicating that the IP address registration/acknowledgment request has been successfully processed to the source device (digital multifunction device 10/control unit 11) of the IP address registration/acknowledgment request (S106). The scan agent computer 50 completes the IP address registration/acknowledgment processing.

In case the multifunction device information corresponding to the received IP address registration/acknowledgment request is stored in the computer (S101; YES), the scan agent computer 50 determines whether the device IP address included in the administration information matches the device IP address included in the received IP address registration/acknowledgment request (S104). In case both IP addresses match each other (S104; YES), the scan agent computer 50 executes S106 and the subsequent steps. In case the both IP addresses do not match each other (S104; NO), the scan agent computer 50 changes the device IP address in the multifunction device administration information having the same MAC address as that but a different device IP address from that in the received IP address registration/acknowledgment request to the device IP address included in the IP address registration/acknowledgment request (S105), then executes S106 and the subsequent steps.

Referring to FIG. 5 again, information stored in the scan agent computer 50 will be further described.

All of the various information stored per user in the scan agent computer 50 can be set by accessing the scan agent computer 50 from a web browser.

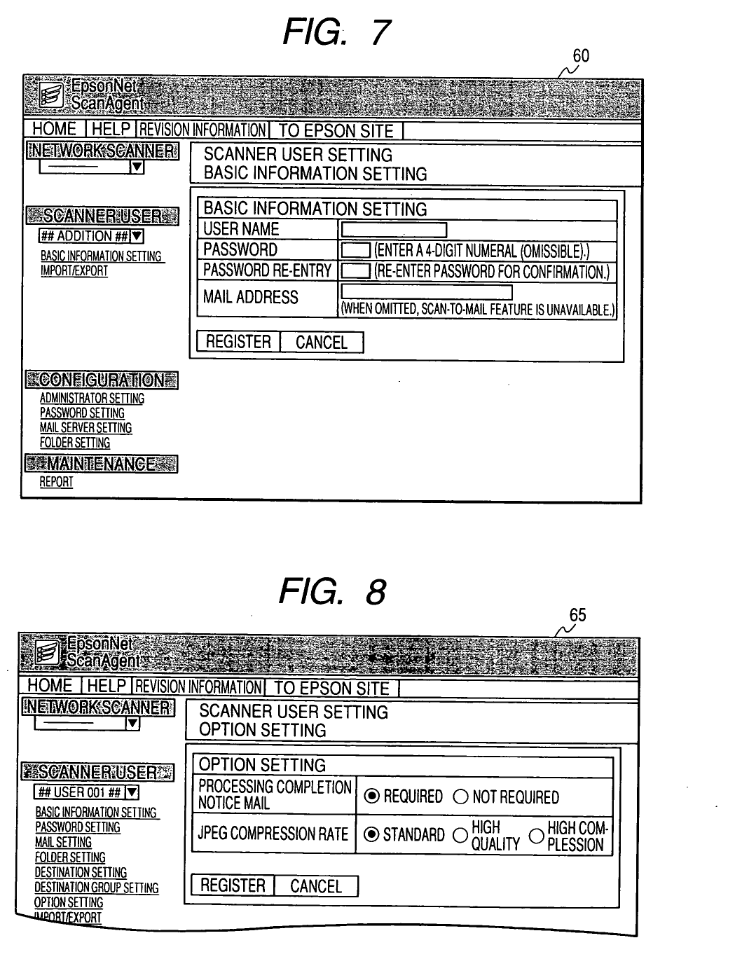

To be more precise, the user administration information comprises a user name, a mail address, a password and information on whether processing completion notice is required. The user administration information can be set using a scan user setting page 60 and an option setting page 65 respectively shown in FIGS. 7 and 8. The information on whether processing completion notice is required refers to information on whether transmission of a processing completion mail (detailed later) is required. The information on whether processing completion notice can be set by operating a radio button (option button) concerning “processing completion notice mail” on the option setting page 65 shown in FIG. 8. The scan user setting page 60 is a web page which can be displayed after a login using an administrator's name and a password. In this way, the user administration information is set by the administrator.

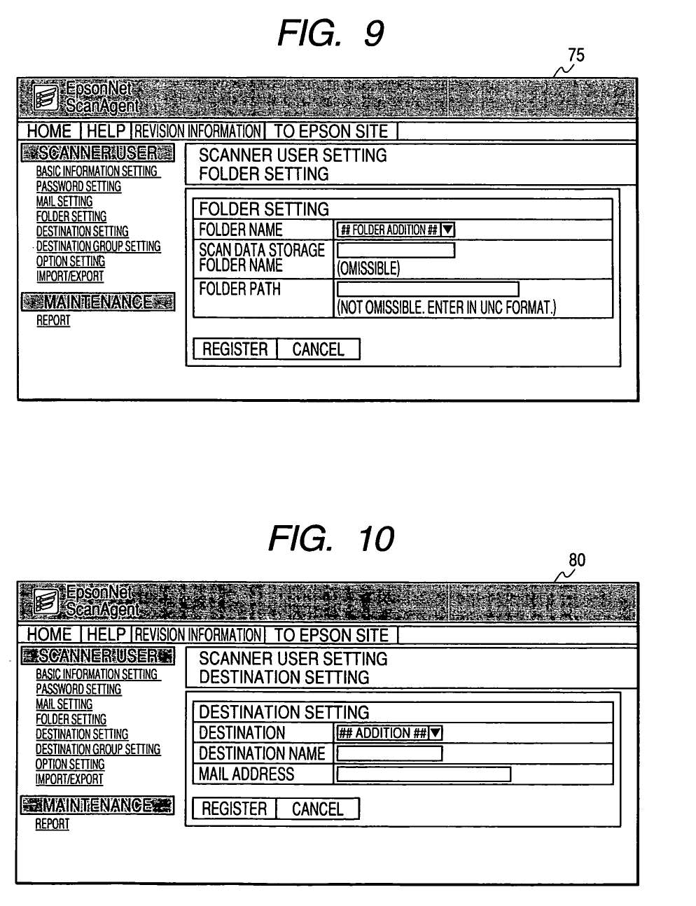

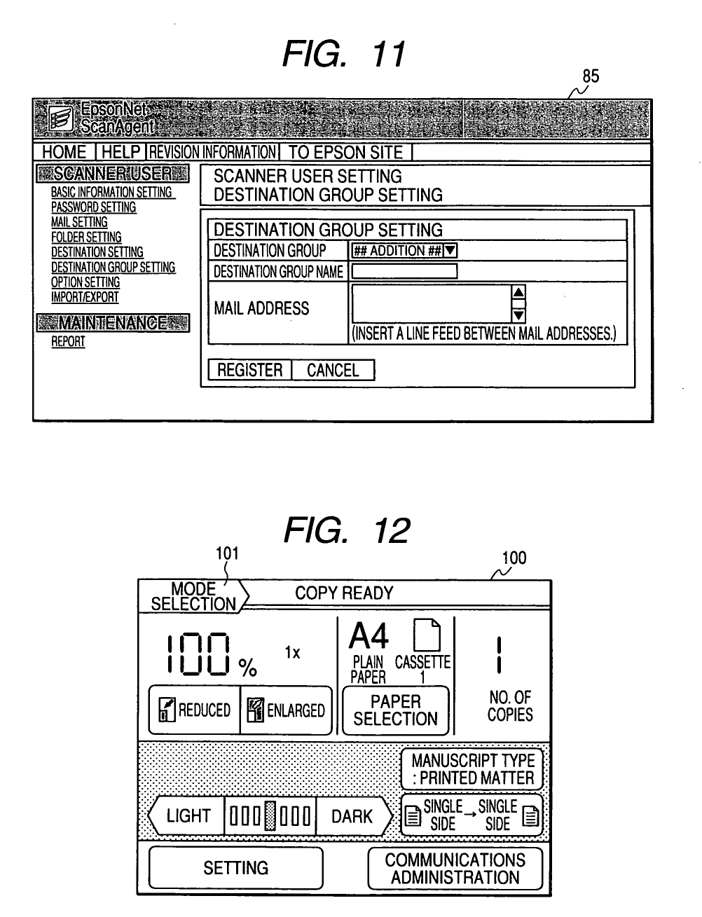

The destination specification information for each user stored in the scan agent computer 50 is information set by the user to whom user administration information is set (whose user registration is complete) using a folder setting page 57, a destination setting page 80 and a destination group setting page 85 respectively shown in FIGS. 9 through 11. These setting pages are web pages which can be displayed after a login which requires a user name and a password (a user name alone in case a password is not set). Information input to each setting page is stored into the HDD of the scan agent computer 50 as information on a user who has performed a login (destination specification information for storage/mail/group).

The scan data transmission system is designed as a system where the information stored in the scan agent computer 50 is used as described below.

The control unit 11 has an operation mode for operating the digital multifunction device 10 as a copier (hereinafter referred to as a copy mode) and an operation mode for operating a system comprising the digital multifunction device 10 and the scan agent computer 50 as a system (scan data transmission system which actually operates) capable of executing scan data transmission processing (data transmission processing made by the scan agent computer 50 and the processing made by the digital multifunction device 10; details are provided later) (hereinafter referred to as a scan mode).

The control unit 11 is designed to typically display a copy basic screen 100 shown in FIG. 12 on the touch screen 31 while operating in the copy mode.

When wishing to cause the control unit 11 to start scan mode operation (when wishing to cause the scan data transmission system to execute scan data transmission processing), the user presses a mode selection button 101 on the copy basic screen 100.

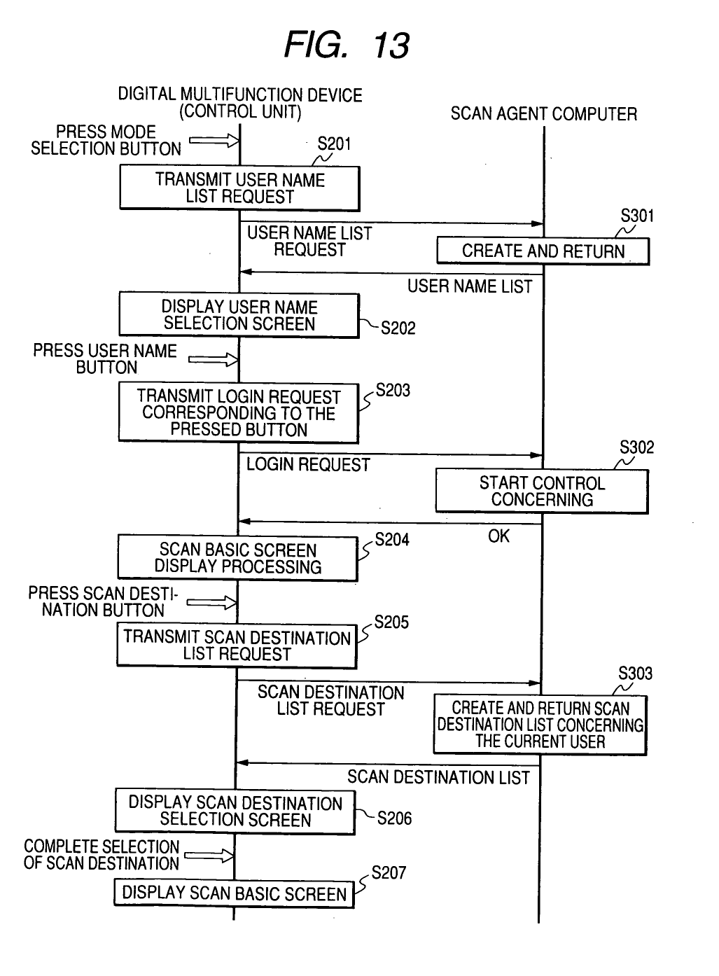

When this operation is made, the control unit 11 starts scan mode operation. As shown in FIG. 13, the control unit 11 transmits a user name list request to the scan agent computer 50 (device having an agent IP address stored in the EEPROM 24) (S201). The scan data transmission system is a system where communications between the control unit 11 and the agent computer 50 are made using HTTP (system where communications of various information between the control unit 11 and the scan agent computer 50 are made using the request body and the response body of HTTP).

Receiving the user name list request, the scan agent computer 50 creates a user name list from the user administration information group stored in the computer and returns the list to the digital multifunction device 10 (S301). The user name list refers to information including the user name of each user and whether the user has set a password.

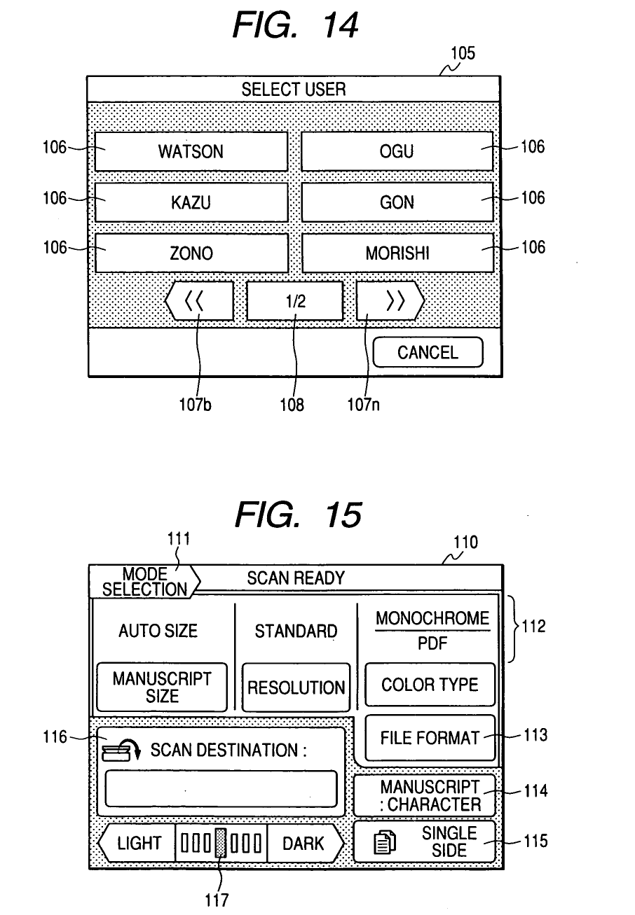

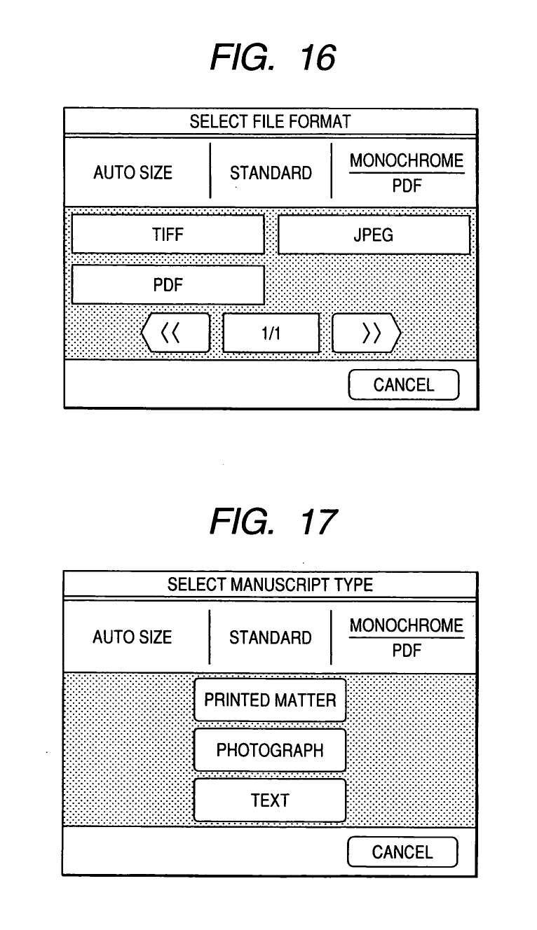

Receiving the user name list, the control unit 11 displays a user name selection screen 105 shown in FIG. 14 on the touch screen 31 based on the user name list (S202). In other words, the control unit 11 displays on the touch screen 31 the user name selection screen 105 comprising a user name button 106 showing each user name included in the received user name list.

In case a user name button 106 on the user name selection screen 105 is pressed, the control unit 11 transmits to the scan agent computer 50 a login request including the user name corresponding to the pressed user name button 106 (S203). In case the user name button 106 pressed pertains to a user who has set a password (refer to FIGS. 5 and 7), the control unit 11 displays a password input screen on the touch screen 31 so as to let the user enter the password. The control unit 11 transmits to the scan agent computer 50 a login request including the password and the user name entered by the user.

Receiving the login request, the scan agent computer 50 checks whether there exists user administration information including the same information as that included in the login request (a user name, or a user name and a password) and starts processing (session administration in the figure) of handling the request from the control unit 11 which has transmitted the login request as a request from the user identified by the user name included in the login request (hereinafter referred to as the current user) (S302).

Receiving this information, the control unit 11 displays the scan basic screen 110 shown in FIG. 15 on the touch screen 31 (S204).

A mode selection button 111 on the scan basic screen 110 is a button which triggers, when pressed, copy mode operation by the control unit 111.

A set value area 112 on the scan basic screen 110 shows set values concerning the manuscript size, resolution, color type, and file format at present point in time. A “Manuscript size” button, a “Resolution” button, a “Color type” button, a “File format” button 113 respectively changes a set value concerning the manuscript size, resolution, color type and file format.

A “Manuscript type” button 114 is used to specify the manuscript type (whether the manuscript is printed matter, a photograph, or a manuscript most of which includes characters). The “Manuscript type” button 114 shows therein a set value (characters in the figure) at that point in time. A single/double side selection button 115 is used to specify whether both sides or single side of a manuscript is to be read. The single/double side selection button 115 also shows therein a set value (single side in the figure) at that point in time.

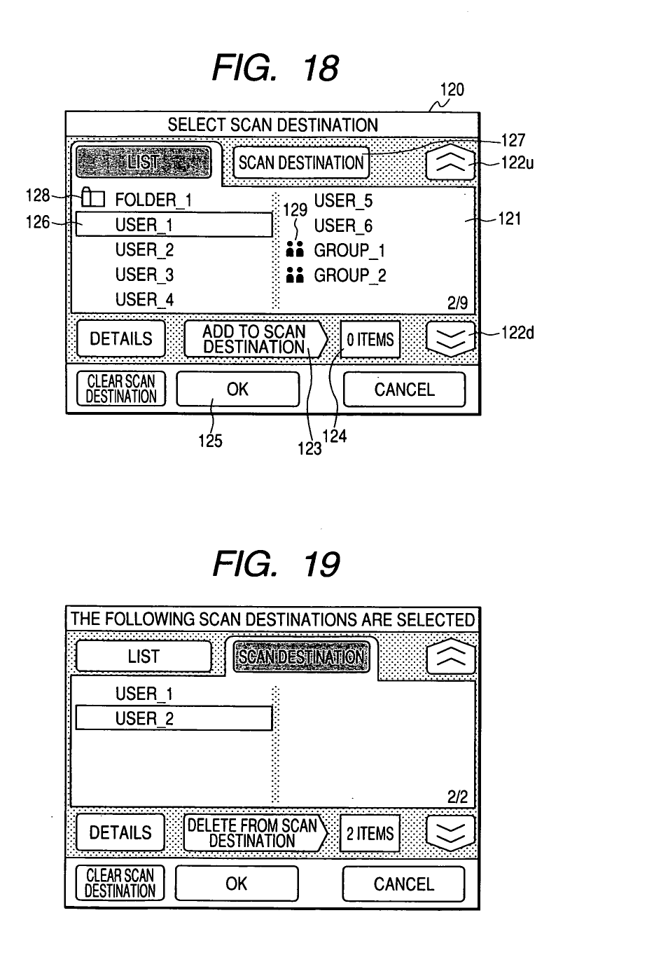

Pressing one of the buttons causes another screen on the touch screen 31. For example, a file format button 113, when pressed, causes a file format selection screen shown in FIG. 18 on the touch screen 31. The manuscript type button 114, when pressed, causes a manuscript type selection screen shown in FIG. 17 on the touch screen 31.

A “Light” button and a “Dark” button provided on the scan basic screen 110 (buttons to adjust the scan density) are buttons which do not cause another screen to appear but causes the display position of a density cursor 117 to be shifted when it is pressed.

A Scan destination button 116 is used to specify the transmit destination (final destination) of scan data (image data generated by the scanner 12).

In case the Scan destination button 116 is pressed, the control unit 11 transmits a scan destination list request to the scan agent computer 50 (FIG. 13: S205).

Receiving the scan destination list request, the scan agent computer 50 creates a scan destination list including the name of each destination specification information item and information on whether the destination specification information item is destination specification information for storage, mail or group, and returns the list to the control unit 11 (S303).

Receiving the scan destination list, the control unit 11 displays a scan destination selection screen 120 shown in FIG. 18 on the touch screen 31 (S206).

A list area 121 of the scan destination selection screen 120 is an area where the name of each destination specification information item pre-registered by the user (such as “FOLDER_{—}1”, “USER_{—}1”: hereinafter also represented as a destination specification information item came) is shown. In the list area 121, as understood from FIG. 18, a graphics 128 and its name (“FOLDER_{—}1”) are shown for each destination specification information item for storage, its name (such as “USER_{—}1”) alone for each destination specification information item for mail, and a graphics 129 and its name (“GROUP_{—}1”) for each destination specification information item for group.

The scan destination selection screen 120 allows selection of an arbitrary number of destination specification information items by way of the operation described below.

The user wishing to select certain destination specification information (destination specification information for storage, destination specification information for mail or destination specification information for group) operates a button 122u and a button 122d to form a selection frame 126 in a portion where the target destination specification information item name is displayed. Then the user presses a “Add to scan destination” button 123.

When the user presses the “Add to scan destination” button 123, the control unit 11 stores selection of destination specification information identified by the destination specification information item name enclosed by the selection frame 126. The control unit 11 increments the numeric value in a selection count display column 124 by “1” as well as erases the destination specification information item name enclosed by the selection frame 126.

In case a plurality of destination specification information items are selected (a plurality of scan data destinations are specified), the user performs the above operation for each destination specification information item and presses an “OK” button 125. A scan destination button 127 on the scan destination selection screen 120, when pressed, causes the scan destination check/deletion screen shown in FIG. 19 to be displayed on the touch screen 31. The user wishing to check the selected destination specification information displays the scan destination check/deletion screen and presses the “OK” button on the scan destination check/deletion screen (or “OK” button on the scan destination selection screen 120).

When the user presses the “OK” button 125 (or “OK” button on the scan destination check/deletion screen), the scan basic screen 110 is displayed where the information concerning the destination specification information selected by the user (a list of destination specification information item names) is displayed in the scan destination button 116.

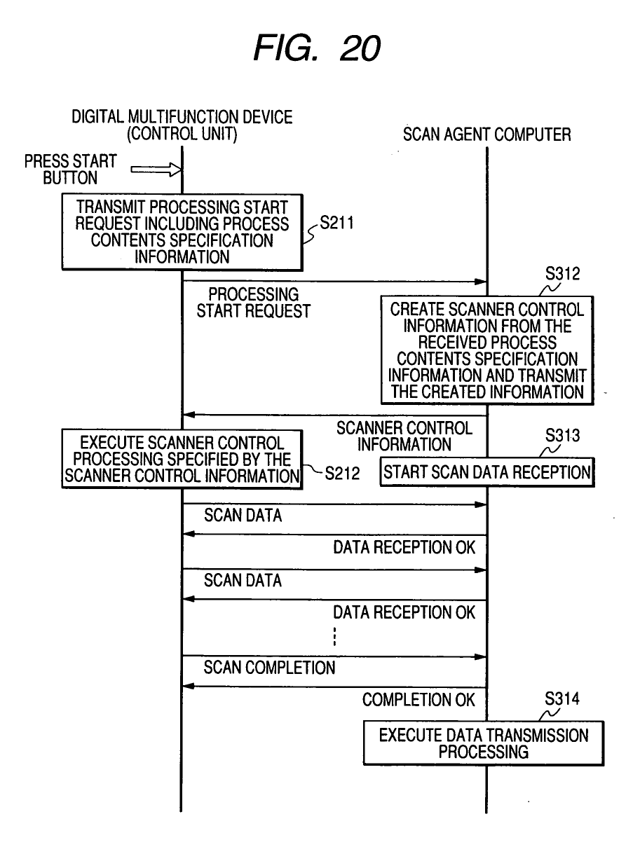

The control unit 11, in case the start button 32 is pressed with a scan destination specified, transmits to the scan agent computer 50 a processing start request including the process contents specification information at that point in time (group of set values displayed on the scan basic screen 110), as shown in FIG. 20 (S201).

Receiving the processing start request, the scan agent computer 50 creates scanner control information based on the process contents specification information included therein and returns the information to the control unit 11 (S312). The scanner control information refers to information obtained by converting each information item (only the information related to control of the scanner 12) in the process contents specification information to information (command) used to control the scanner.

Receiving the scanner control information, the control unit 11 performs the control processing specified by the scanner control information on the scanner 12 (S212). In short, the control unit 11 starts control of the scanner 12.

The control unit 11 enters a state of transferring scan data transmitted from the scanner 12 to the scan agent computer 50.

The scan agent computer 50 which has returned scanner control information to the control unit 11 starts to receive scan data transmitted from the control unit 11 and stores the scan data into the HDD (S313). The scan agent computer 50, receiving the information indicating that transmission of all scan data is complete (completion of scan in the figure) from the control unit 11, performs data transmission (S314).

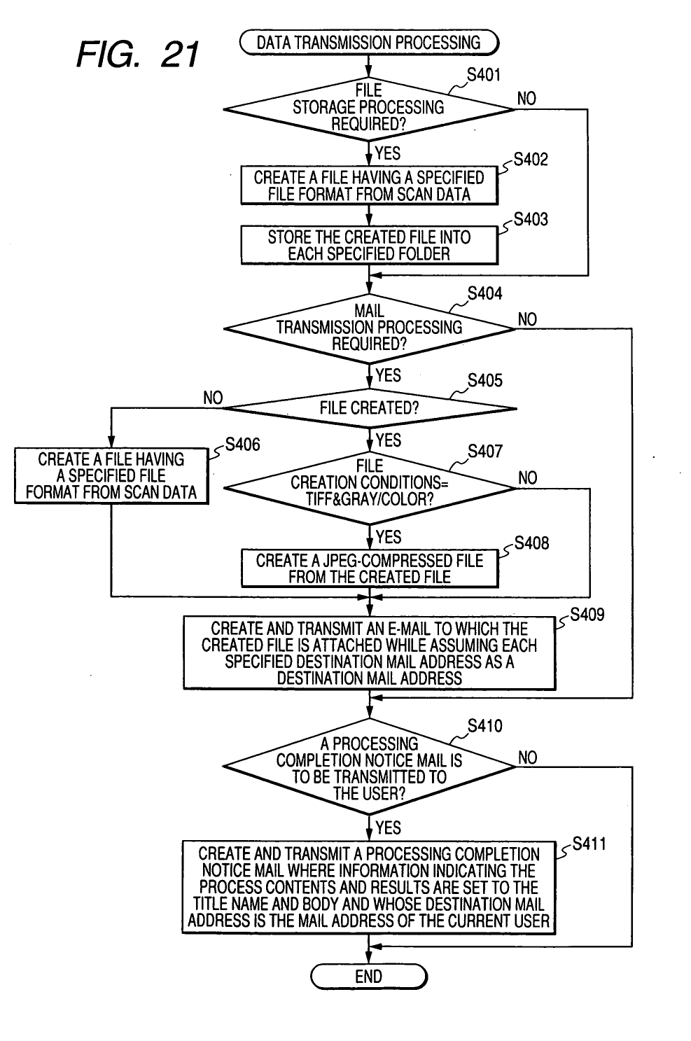

As shown in FIG. 21, during the data transmission, the scan agent computer 50 first determines whether it is necessary to perform file storage processing (processing to store a file of received scan data into a shared folder) (S401) In other words, the scan agent computer 50 determines whether the process contents specification information (hereinafter referred to as current process contents specification information) previously received from the digital multifunction device 10 includes the destination specification information for storage.

Then, the scan agent computer 50, in case it is necessary to execute file storage processing (S401; YES), creates a file having a file format specified by the current process contents specification information from the received scan data (S402). Next, the scan agent computer 50 performs the processing of storing the created file into each folder specified by the current process contents specification information (S403) by referencing the destination specification information concerning the current user in the HDD.

In the processing of S402 described above, in case the specified file format and color type are respectively “TIFF” and “monochrome”, an MMR (G4)-compressed TIFF file is created. In case the specified file format and color type are respectively “TIFF” and “color” or “gray scale”, an uncompressed TIFF file is created. The processing of S403 (and S402) is processing of storing (generating) a file having a name generated from the current date and time.

The scan agent computer 50, having completed the processing of S402 and S403, or recognizing that it is not necessary to execute file storage processing (S401; NO), determines whether it is necessary to execute mail transmission processing (processing of transmitting an e-mail to which a file of received scan data is attached) (S404). In other words, the scan agent computer 50 determines whether the current process contents specification information includes a destination specification information item name for mail and a destination specification information item name for group.

In case it is necessary to perform mail transmission processing (S404; YES), the scan agent computer 50 determines whether a scan data file has been created (S405). In case the scan data file has not been created (S405; NO), the scan agent computer 50 creates a file having a file format specified by the current process contents specification information from the received scan data (S406). In the processing of S406, in case the specified file format and color type are respectively “TIFF” and “monochrome”, an MMR (G4)-compressed TIFF file is created. In case the specified file format and color type are respectively “TIFF” and “color” or “grayscale”, an uncompressed TIFF file is created.

Next, the scan agent computer 50 performs the processing of transmitting an e-mail to which the created file is attached to each destination specified by the current process contents specification information (S409) by referencing the destination specification information concerning the current user in the HDD.

In case the scan data file has been created (S405; YES), the scan agent computer 50 determines whether the conditions are satisfied that the specified file format and color type are respectively “TIFF” and “color” or “gray scale” (S407).

In case the conditions are not satisfied (S407; NO), the scan agent computer 50 performs the processing of transmitting an e-mail to which the created file is attached to each destination specified by the current process contents specification information (S409).

In case the conditions are satisfied (S407; YES), the scan agent computer 50 creates a JPEG-compressed TIFF file from the created file (an uncompressed TIFF file in this case) (S408) and performs the processing of transmitting an e-mail to which the created file is attached to each destination specified by the current process contents specification information (S409).

The scan agent computer 50, having completed the processing of S409, or recognizing that it is not necessary to execute mail transmission processing (S404; NO), determines whether the current user needs to transmit a processing completion notice mail (S410). In other words, the scan agent computer 50 determines whether the information on whether processing completion notice is required concerning the current user (refer to FIGS. 5 and 8) is information indicating that it is necessary to transmit a processing completion notice mail.

In case the current user needs to transmit a processing completion notice mail (S410; YES), the scan agent computer 50 sets information indicating the executed process contents and results to the title name and the body, then creates and transmits a processing completion notice mail whose destination mail address is the mail address of the current user (refer to FIGS. 5 and 7) (S411).

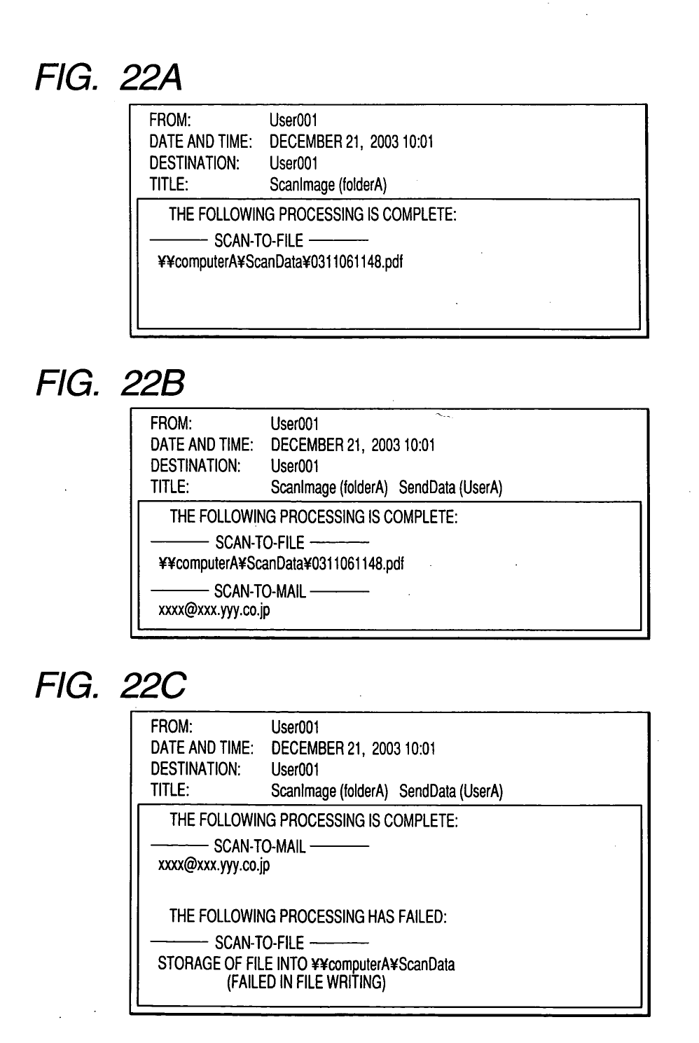

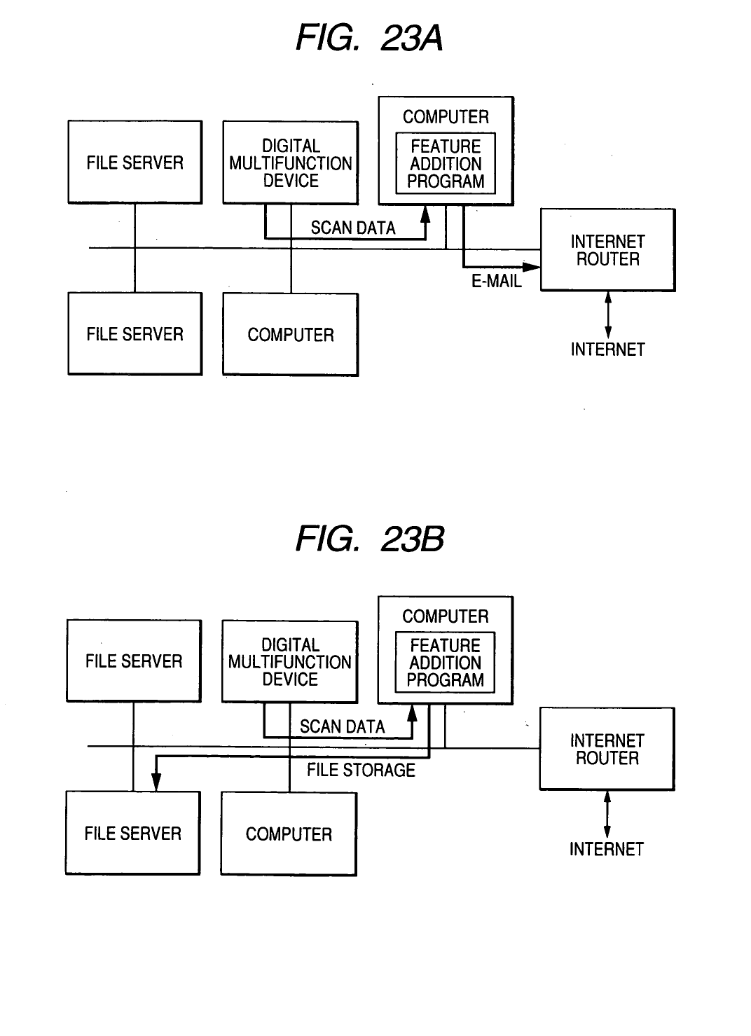

To be more precise, in S411, the scan agent computer 50 transmits a processing completion notice mail whose title is a character string as a combination of a destination specification information item name (“folderA”, “UserA”) concerning each destination and information indicating the type of processing made concerning each destination (“ScanImage”, “SendData”) and whose body is a sentence indicating the details and results of each executed process by destination, as shown in FIGS. 22A through 22C. The scan agent computer 50 (scan agent program 40) is a device (program) capable of responding to a download request of a file stored in a shared folder set in the device as well as a device (program) which includes the URL of a file stored in the shared folder set in the device in the processing completion notice mail.

Having completed the processing of S411, the scan agent computer 50 terminates the data transmission processing. In case the current user does not need to transmit a processing completion notice mail (S410; NO), the scan agent computer 50 terminates the data transmission processing without transmitting a processing completion notice mail.

In case information is not received from the control unit 11 for a duration longer than a prespecified period, or information indicating an error is received from the control unit 11, the scan agent computer 50 performs the data transmission processing while skipping the steps S404 through S409. That is, the control unit 11 performs the processing of storing into a specified folder a file of scan data (part of image data of a manuscript) received at that point in time and the processing of transmitting a processing completion notice mail.

As detailed hereinabove, a scan data transmission system according to this embodiment is a system which allows the user to issue, at a time, execution instructions on processing of storing an image data file of a manuscript into a folder and processing of transmitting an e-mail to which the image data file of the manuscript is attached, as well as a system which completes both processes by way of a singles can of the manuscript. Thus, by using the scan data transmission system, it is possible to perform processing of storing an image data file of a manuscript into a folder and transmitting an e-mail to which the data file of the manuscript is attached in a fashion which requires less time and workload than in a related art.

In the scan data transmission system according to this embodiment, in case the file format and color type are respectively “TIFF” and “color” or “gray scale”, a JPEG-compressed TIFF file is created for e-mail transmission and an uncompressed TIFF file is created for file storage. In such a case, the scan data transmission system creates a TIFF file for e-mail transmission from a TIFF file created for file storage.

The scan data transmission system is a system which allows a small-size file to be attached to an e-mail without separately setting a file format concerning a file to be attached to an e-mail and a file format concerning a file to be stored, as well as a system which efficiently performs the processing therefor.

Variation

The scan data transmission system according to the embodiment may be modified in a variety of fashions. For example, while the scan data transmission system is a system comprising one or more digital multifunction devices 10 and a scan agent computer 50, a single device (scan data transmitter) having the same capability as the scan data transmission system may be provided based on the technology used in the scan data transmission system.

The digital multifunction device 10 may be a dedicated device, not a combination of devices. Particular layout of the screen displayed on the digital multifunction device 10 may be different from that described above.

1. A scan data transmitter to be connected to a network comprising:
an image data generator that generates image data representing an image on a manuscript set thereon;
a user-interface unit that allows a user to specify process contents to be executed and allows the user to specify both of or either a file path of a folder into which a file of image data generated by the image data generator is stored and a designation mail address of an e-mail to which the file of the image data is attached; and
an image data transmitter that, when a processing start instruction is input, performs:
in case the user specifies only the file path to the user-interface unit, first storage processing which causes the image data generator to generate the image data and stores a file concerning the image data into the folder identified by the specified folder path,
in case the user specifies only the designation mail address to the user-interface unit, first mail transmission processing which causes the image data generator to generate the image data and transmits an e-mail to which a file concerning the image data is attached to the designation mail address specified by the user, and
in case the user specifies the file path and the designation mail address, second storage processing which causes the image data generator to generate the image data and stores a file concerning the image data into a folder identified by the folder path specified by the user and second mail transmission processing which transmits the e-mail to which a file concerning the image data is attached to the designation mail address specified by the user.

2. The scan data transmitter according to claim 1, wherein the image data transmitter skips the first mail transmission processing and the second transmission processing and executes the first storage processing and the second storage processing, in case generation of image data by the image data generator is not successfully terminated.

3. The scan data transmitter according to claim 1, wherein the user-interface unit allows the user to specify a file format, and
in case the file format specified by the user to the user-interface means is a predetermined file format which is either a compressed format or uncompressed format, the image data transmitter assumes the file format as the compressed file format of the predetermined file format for e-mail transmission processing and assumes the file format as the uncompressed file format of the predetermined file format for file storage processing.

4. The scan data transmitter according to claim 3, wherein, in case the user specifies the file path and the mail address to the user-interface unit, the image data transmitter performs the second storage processing which causes the image data generator to generate the image data, creates an uncompressed file having the predetermined file format concerning the image data and stores the file into a folder identified by the folder path specified by the user, and performs the second mail transmission processing of transmitting the e-mail to which the uncompressed file is attached.

5. As can data transmission system comprising an information processor and an auxiliary information processor,
wherein the auxiliary information processor includes:
a first processing execution unit which stores a file concerning image data transmitted from the auxiliary information processor into a folder identified by a folder path transmitted from the information processor;
a second processing execution unit which performs processing of transmitting an e-mail, to which a file concerning the image data transmitted from the information processor is attached, to a designation mail address transmitted from the information processor; and
a third processing execution unit which performs processing of storing a file concerning the image data into a folder identified by a folder path transmitted from the information processor and processing of transmitting an e-mail to which a file concerning the image data is attached to the designation mail address transmitted from said information processor, and
wherein the information processor includes:
an image data generator for generating image data corresponding to an image on a manuscript;
a user-interface unit which allows the user to specify processing contents to be executed and allows the user to specify both of or either a file path of a folder into which a file of image data generated by the image data generator is stored and a designation mail address of an e-mail to which the file of image data generated by the image data generator is attached; and
a controller that, when a processing start instruction is input, operates:
in case the user specifies only a file path to the user-interface unit, the first processing unit;
in case the user specifies only a mail address to the user-interface unit, the second processing unit; and
in case the user specifies a file path and a mail address to the user-interface unit, the third processing unit.

6. The scan data transmission system according to claim 5, wherein
when the controller operates the first processing unit, the controller causes the image data generator to generate the image data and transmits the image data and the folder path specified by the user to the auxiliary information processor,
when the controller operates the second processing unit, the controller causes the image data generator to generate image data and transmits the image data and the mail address specified by the user to the auxiliary information processor, and
when the controller operates the third processing unit, the controller causes the image data generator to generate the image data and transmits the image data and the file path and the mail address which are specified by the user to the auxiliary information processor.

7. The scan data processing system according to claim 5, wherein the auxiliary information processor is a computer storing an auxiliary information processing program for operating a computer to function as the first processing execution unit, the second processing execution unit, and the third processing execution unit.
